(19) United States
(12) Patent Application Publication
(10) Pub. No.: US 2012/0058851 A1
(43) Pub. Date: Mar. 8, 2012

(54) POWER TRANSMITTING TOOTHED BELT AND POWER TRANSMITTING DEVICE

(75) Inventors: Shoichiro Shimizu, Osaka (JP); Hiroshi Sakamoto, Osaka (JP); Masaru Kanamori, Osaka (JP)

(73) Assignee: TSUBAKIMOTO CHAIN CO., Osaka (JP)

(21) Appl. No.: 13/217,766

(22) Filed: Aug. 25, 2011

(30) Foreign Application Priority Data
Sep. 8, 2010 (JP) 2010-201195

(51) Int. Cl. F16H 7/02; F16G 1/12; F16G 1/28

(52) U.S. Cl. 474/153; 474/205

(57) ABSTRACT

A power transmitting toothed belt having improved positioning accuracy between the toothed belt and a pulley, increased durability, and reduced contact noise, comprising a rubber back layer, a plurality of core wires and a rubber layer having a plurality of belt teeth, wherein the belt teeth are at oblique angle with respect to the direction of the width of the belt. The belt teeth intersect with straight pulley teeth having a pitch equal to the pitch of the belt teeth.

### CROSS REFERENCE TO RELATED APPLICATIONS)

This application claims priority on the basis of Japanese Patent Application No. 2010-201195, filed on Sep. 8, 2010 in the Japan Patent Office. The disclosure of Japanese Patent Application No. 2010-201195 is herein incorporated by reference in its entirety.

### FIELD OF THE INVENTION

The invention relates to a power transmitting toothed belt and a power transmitting device for use in industrial machines in general.

### BACKGROUND OF THE INVENTION

A typical power transmitting toothed belt has straight belt teeth that extend parallel to the direction of the width of the belt. Alternatively, the belt may have v-shaped teeth as shown in Japanese Laid-open Patent Application 2000-346138. Other devices for transmitting power through a toothed belt include: an obliquely-toothed wheel that drives a toothed belt having oblique teeth as shown in Japanese Patent No. H03-3090; a transmission device that uses a toothed belt having curved belt teeth as shown in Japanese Utility Model No. S63-18661; and a toothed belt driving device having curved pulley teeth as shown in Japanese Utility Model No. S61-20948.

There are problems with the power transmitting devices of the prior art which have straight belt teeth. As shown in FIG. 18, because of the gaps BR, there is backlash between the teeth 215 of the belt 210 and the teeth 222 of the pulley 220 when the rotation direction of the pulley 220 is reversed. The positioning of the belt 210 relative to the pulley 220 becomes inaccurate.

If the gaps between the pulley teeth 222 and the belt teeth 215 are eliminated to improve positioning accuracy, the belt teeth 215 and the pulley teeth 222 interfere, increasing contact resistance. Thus, the durability of the toothed belt 210 is low and it becomes difficult to suppress contact noise.

In the prior art belts, core wires embedded in the back layer of rubber of the belt extend obliquely in relation to the longitudinal direction of the belt, as shown in FIG. 19. The belt is unable to sustain the load imparted by the pulley to the belt, causing elastic elongation of the belt along with positioning errors between the belt teeth and the pulley teeth.

### SUMMARY OF THE INVENTION

Accordingly, the invention aims at solving the aforementioned prior art problems by providing a power transmitting toothed belt and a power transmitting device capable of improving positioning accuracy between a power transmitting toothed belt and a pulley, improving durability of the belt and suppressing contact noise.

The power transmission in accordance with the invention comprises a toothed belt and a toothed pulley in mesh with the toothed belt and rotatable on an axis of rotation. The toothed belt comprises a back layer in the form of an endless loop which extends along a circumferential direction. The toothed belt is composed of rubber. A toothed layer is secured to the back layer, and extends along the back layer in the circumferential direction. The toothed layer is also composed of rubber, and has a plurality of belt teeth extending toward the inside of the loop. A plurality of core wires is embedded in the belt between the back layer and the toothed layer. The core wires extend along the circumferential direction of the loop.

The pulley comprises a plurality of straight teeth in mesh with the teeth of the belt. The pulley teeth extend widthwise of the pulley and parallel to the axis of rotation of the pulley. The belt is arranged to travel along a direction of travel perpendicular to the direction of the axis of rotation of the pulley. The pitch of the pulley teeth is equal to the pitch of the belt teeth.

The plurality of belt teeth extends at an oblique angle with respect to the direction of the width of the belt which is measured parallel to the axis of rotation of the pulley. The teeth of the belt intersect with the pulley teeth, which extend parallel to the direction of the width of the belt. The pitch of the belt teeth is equal to the pitch of the straight pulley teeth. Thus, the belt teeth contact and engage the straight pulley teeth gradually, one by one, without a rapid increase in the contact area as is the case with current toothed belt transmissions.

Accordingly, the power transmitting toothed belt of the invention prevents the rattling that would be otherwise generated when the belt teeth contact the straight pulley teeth. It further prevents backlash and bias of the belt in the direction of the width of the pulley. The belt of the invention also improves positioning accuracy between the belt teeth and the straight pulley teeth by preventing elastic elongation of the rubber back layer and the toothed layer. It further relieves contact noise and improves durability of the pulley and the belt by reducing wear of the belt teeth and of the pulley teeth.

In a preferred embodiment, the twisting direction of each of the plurality of core wires is the same. Because the core wires are embedded into the rubber back layer in the circumferential direction and the twisting directions are the same, the invention prevents the load (thrust force) from being biased in direction of the width of the pulley. Positioning errors between the belt teeth and the pulley teeth are prevented and durability is increased due to reduced belt wear.

In another embodiment, the belt teeth are tapered. That is, the width of each tooth becomes narrower proceeding from the base of the tooth toward the top. A load acting on the belt, i.e., a thrust force, is released along the surface of the belt tooth. Bias in the direction of the width of the belt is prevented and positioning error is reduced.

### BRIEF DESCRIPTION OF DRAWINGS

FIG. 1A is a perspective view of a toothed belt and power transmitting device according to the invention;

FIG. 1B is an enlarged cross-sectional view of the toothed belt as shown in FIG. 1A;

FIG. 2 is a plan view of a power transmitting device according to the invention;

FIG. 3 is a perspective view, partly in cross-section, of a part of a toothed belt according to the invention;

FIG. 4 is a plan view of the toothed belt of the invention, showing the core wires embedded into the back layer of the belt;

FIG. 5 is another plan view of the toothed belt of the invention, showing the core wires embedded into the back layer of the belt;

FIG. 6 is a perspective view showing one step of a manufacturing method of the toothed belt of the invention;

FIG. 7 is a diagram of a method for measuring the amplitude of the toothed belt of the invention;

FIG. 8 is a graph showing a comparison of values of maximum amplitude of vibration of the toothed belt of the present invention and the prior art;

FIG. 9 is a graph showing a comparison of amplitude converging time of the toothed belt of the present invention and the prior art;

FIG. 10 is a graph showing a comparison of the durability of the toothed belt of the present invention and the prior art;

FIG. 11 is a diagram illustrating a method for measuring positioning accuracy of the toothed belt of the invention;

FIG. 12 is a graph showing a comparison of the positioning accuracy of the toothed belt of the present invention and the prior art;

FIG. 13 is a graph showing a comparison of belt mounting tension and positioning accuracy of the toothed belt of the present invention and the prior art;

FIG. 14 is a graph showing a comparison of repetition accuracy of the toothed belt of the present invention and the prior art;

FIG. 15 is a graph comparing the noise level of the toothed belt of the present invention and the prior art;

FIG. 16 is a diagram illustrating a method for measuring the elongation and load of the toothed belt;

FIG. 17 is a graph showing a comparison of the relationship between elongation and load of the power toothed belt of the invention and that of the prior art;

FIG. 18 is an enlarged side elevational showing the engagement of a prior art toothed belt with a pulley; and

FIG. 19 is a plan view showing the prior art toothed belt.

### DETAILED DESCRIPTION OF THE PREFERRED EMBODIMENTS

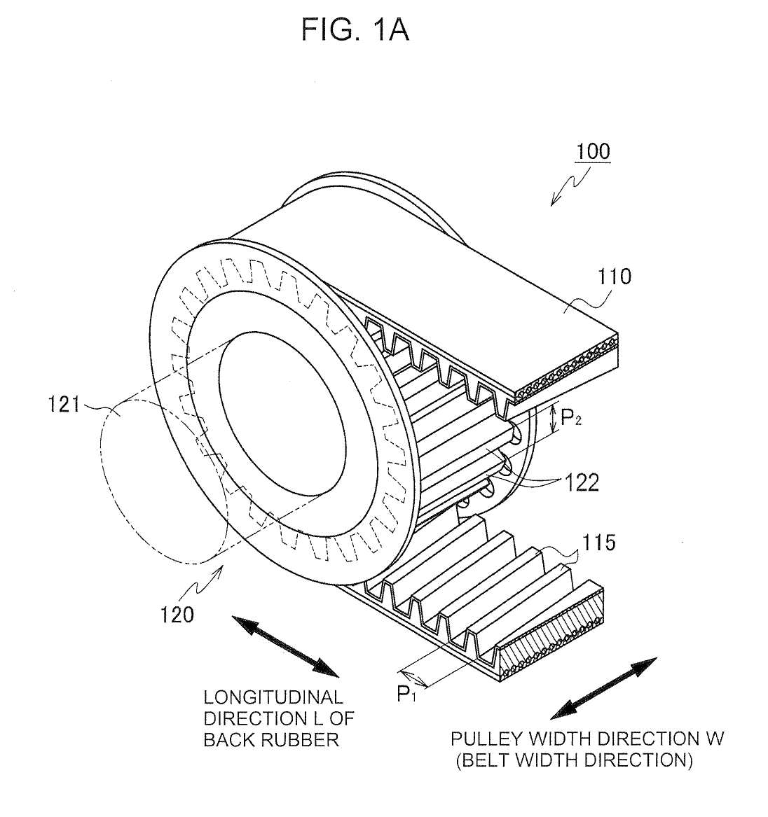

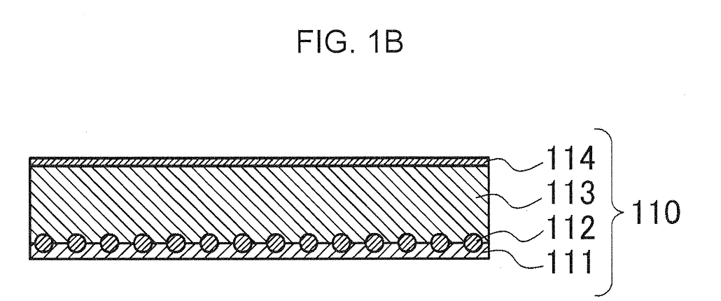

As shown in FIG. 1A, the power transmitting device 100 of the first embodiment of the invention has a pulley 120 that rotates on a shaft 121, and a toothed belt 110 that is wound around the pulley 120 to transmit power. The device 100 transmits power from the toothed belt 110 to the pulley 120 or from the pulley 120 to the toothed belt 110.

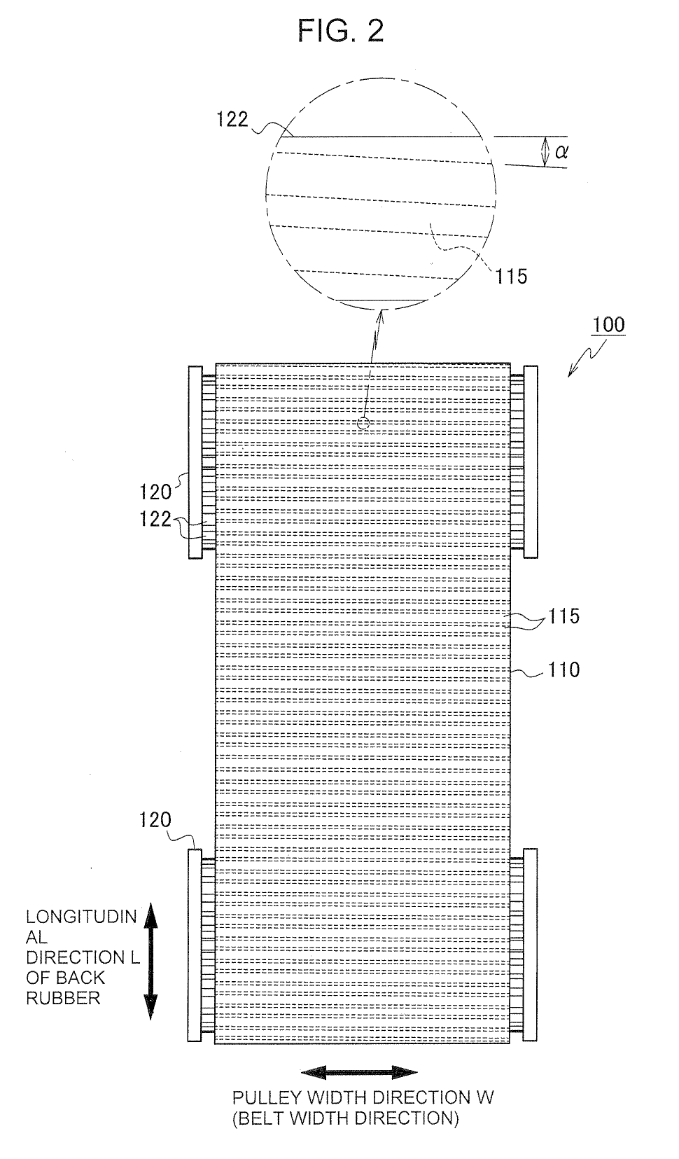

As shown in FIG. 1B, the toothed belt 110 of the power transmitting device 100 has a back layer 111 composed of rubber, a plurality of core wires 112 embedded into the back layer 111 and extending along longitudinal direction L (FIG. 1A) of the back layer 111, and a toothed rubber layer 113 forming a plurality of belt teeth 115 (FIG. 1A) on the plurality of core wires 112. A ground fabric layer 114 overlies the belt teeth. The device 100 transmits power between the toothed belt 110 and the pulley 120 by engagement of the belt teeth 115 with straight pulley teeth 122, which extend in the direction of the width of the pulley 120, i.e., parallel to the axis of ration of the pulley. As shown in FIG. 2, the toothed layer 113 is wound around pulleys 120 and the longitudinal direction L of the back layer 111 is aligned with the circumferences of the pulleys 120.

As shown in FIG. 2, the belt teeth 115 extend at an oblique angle c with respect to the direction of the width of the belt which is measured parallel to the axis of rotation of the pulley. The belt teeth 115 engage with the plurality of straight pulley teeth 122. The pitch P₁ (FIG. 1A) of the belt teeth 115 is equal to the pitch P₂ of the pulley teeth 122.

The belt teeth 115 engage with the straight pulley teeth 122 gradually and without a rapid increase in contact area, preventing rattling that would otherwise be generated when the belt teeth 115 contact the straight pulley teeth 122. The invention also prevents backlash and bias of the belt 110 along direction of the width of the pulley W and elastic elongation of the rubber back layer 111 and the toothed layer 113. The power transmitting device 100 improves positioning accuracy between the belt teeth 115 and the pulley teeth 122 and increases the durability of the belt 110 and the pulley 120 by reducing wear of the belt teeth 115 and the pulley teeth 122.

The angle α at which the belt teeth 115 intersect the pulley teeth may be any angle, provided that the pitches P₁ and P₂ of the belt teeth 115 and straight pulley teeth 122 are equal so that the teeth smoothly and serially engage one another while preventing entanglement of the teeth when the belt tooth 115 enters the space between the neighboring straight pulley teeth 122. In one embodiment, the angle α is preferable to be 0.5 degrees or less but greater than 0 degrees.

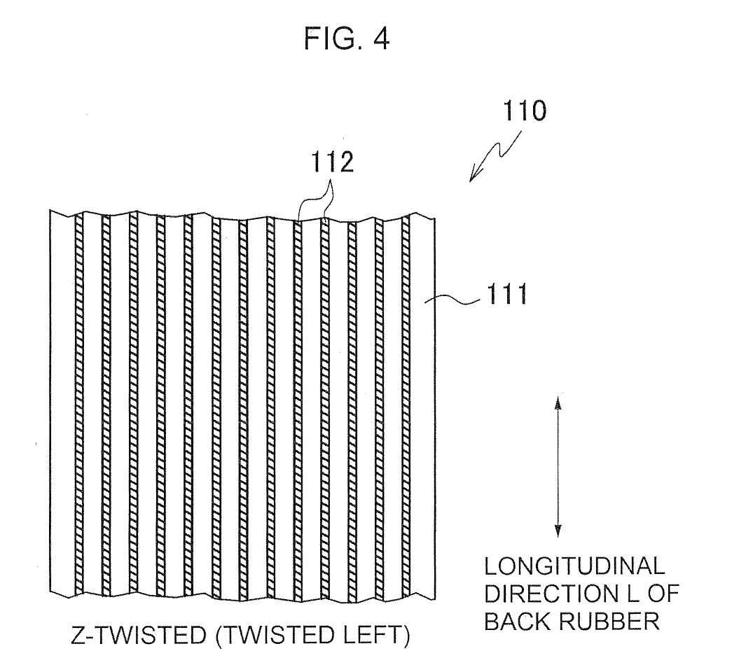

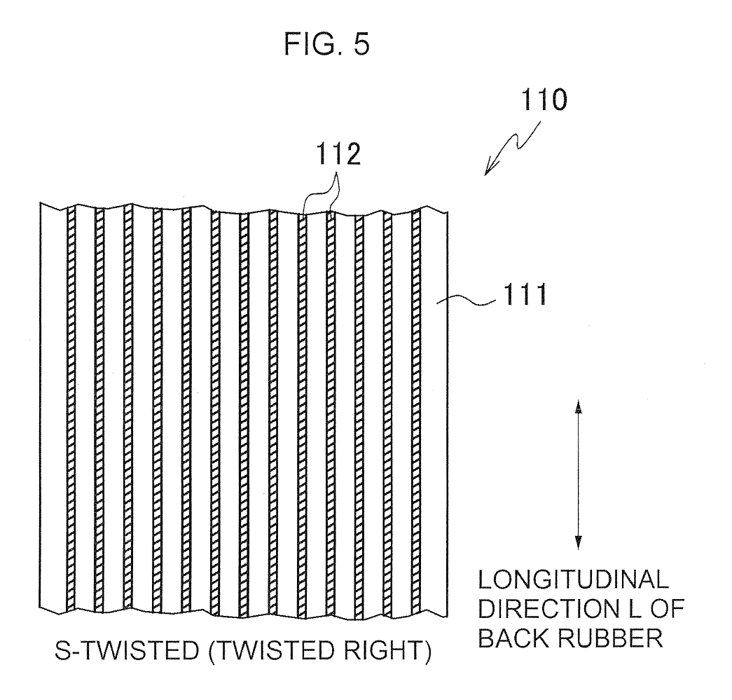

As shown in FIGS. 1, 4 and 5, the core wires 112 are embedded into the rubber back layer 111 and extend along the longitudinal direction L of the rubber back layer. Each of the core wires is composed of a plurality of twisted strands and the twist direction of each of the core wires 112 is the same. The core wires 112 may be unified in a left (Z) twisting direction as shown in FIG. 4 or in a right (S) twisting direction as shown in FIG. 5. Rigidity of the belt 110 is improved along the longitudinal direction L of the rubber back layer 111, and bias in the direction of the width of the pulley is cancelled by the twist of the core wires 112. Durability is increased while elastic elongation and positioning errors are reduced.

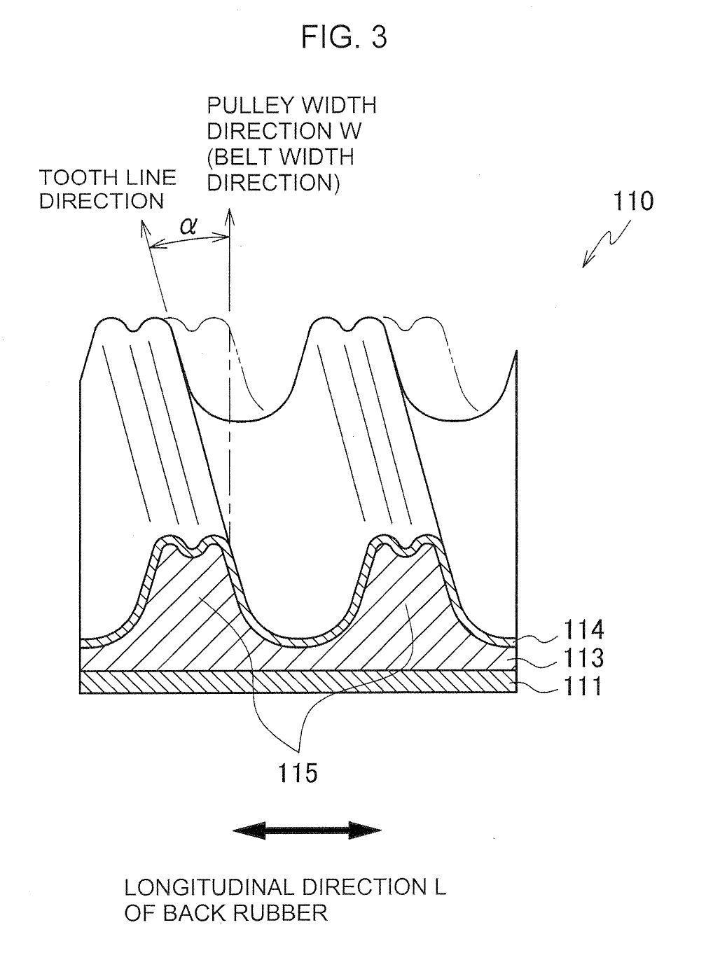

As shown in FIG. 3, a cross-section of the belt teeth 115 cut by an imaginary plane in the longitudinal direction L and orthogonal to the back layer 111 is tapered so that each tooth becomes wider in the direction from the tooth toward the back layer 111. A force acting from the straight pulley teeth 122 to the belt teeth 115 is released along a surface of the belt teeth 115, preventing bias and positioning error.

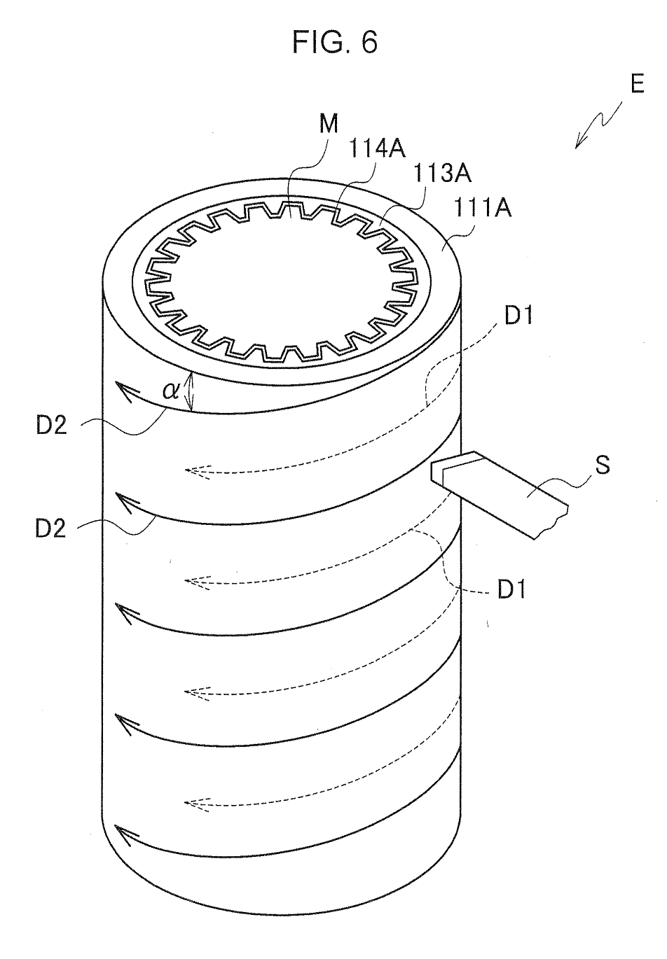

As shown in FIG. 6, the belt 110 is manufactured by the steps of: winding a ground fabric 114A and a toothed rubber 113A around a cylindrical mold M in which tooth molds are formed corresponding to the plurality of belt teeth 115; winding the core wires 112 in a diagonal direction D1 forming the angle α with respect to the circumferential direction around the toothed rubber 113A; forming a cylindrical compact E by winding a rubber back layer 111A around the core wires 112; vulcanizing the cylindrical compact E; and cutting the circumferential surface of the cylindrical compact E by a cutting blade S. The belts are cut out of the cylindrical compact E with the cutting blade S along a direction D2 that is parallel with the diagonal direction D1. The blade is positioned to produce a belt having the desired width. The belt teeth in the resulting belt 115 extend at an oblique angle α with respect to the direction of the width of the belt. Using this simple method, the toothed belt according to the invention 110 can be formed by a technique that is similar to that used in the manufacture of conventional toothed belts, the principal difference being the diagonal direction of winding the core wires and the diagonal direction of cutting the belt.

In one embodiment, the power transmitting device of the invention may have multiple toothed belts of the invention wound around a plurality of pulleys.

The performance of the power transmitting device 100 of the invention is shown by comparing the toothed belt 110 of the invention with a toothed belt having straight belt teeth (hereinafter referred to as a “prior art belt”).

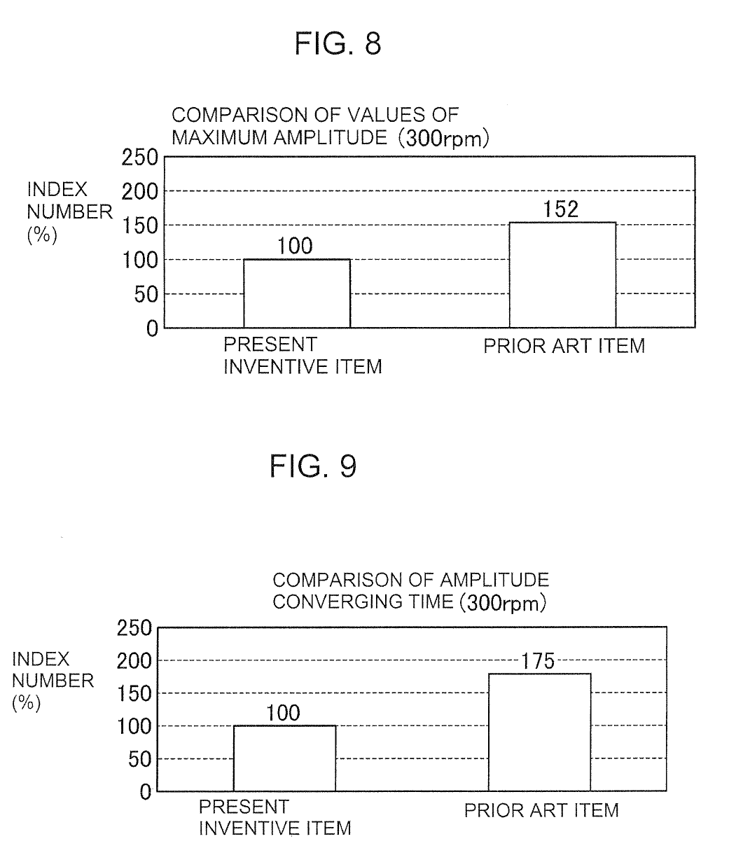

Index numbers (%) in FIGS. 8 through 10, 12, 13 through 15 and 17 are numerical values indicating measured values as a percentage of a standard value, the standard value being 100.

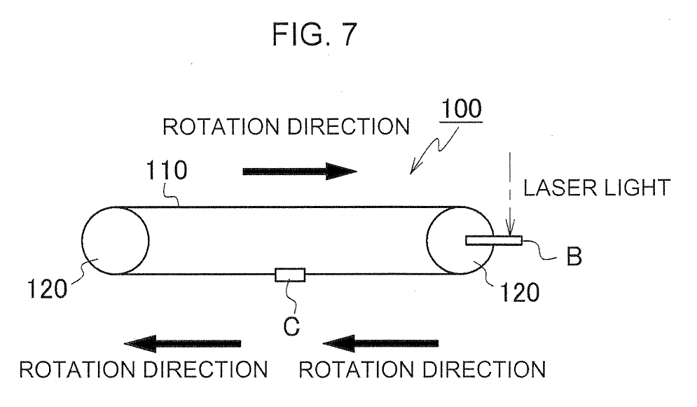

As show in FIG. 7, the amplitude of vibration of the belt 110 is measured by connecting and fixing a measuring bar B to the pulley 120 of the power transmitting device 100, driving the belt 110 in the rotation direction indicated by thick arrows in the figure while holding the belt 110 by a clamp C and detecting a laser light reflected from the measuring bar B.

As shown in FIGS. 8-9, when driven at a rate of 300 rpm, the index number of the amplitude maximum value of the invention is 100, while the index number is 152 for the prior art belt; and the index number of the amplitude converging time of the invention is 100, while the index number is 175 for the prior art belt. As compared to the prior art belt, these results indicate that the invention prevents rattling which would otherwise be generated from contact between the belt teeth 115 and the pulley teeth 122, bias in the direction of the width of the pulley, and backlash.

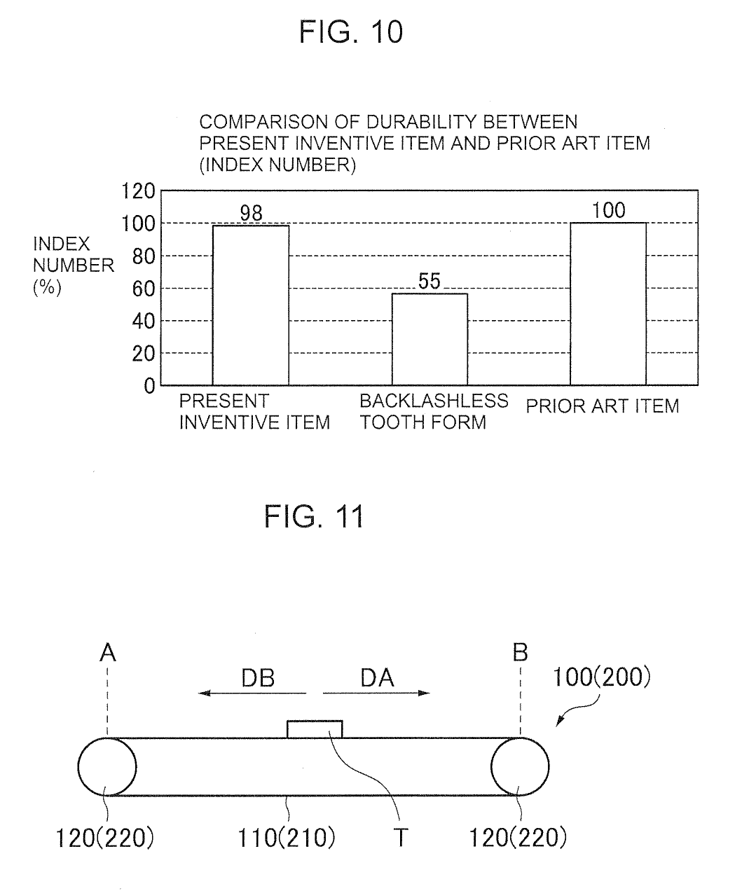

FIG. 10 shows durability of the present invention as compared to the straight-toothed prior art belt described above and a prior art belt having a “backlashless” tooth form. The index of durability of the invention (98) is comparable to that of the straight-toothed prior art belt (100), and a vast improvement to the durability of the “backlashless” tooth form (55). The durability of the belt 110 of the invention is enhanced because wear is reduced by preventing rattling that would otherwise be generated from contact between the belt teeth 115 and the pulley teeth 122, preventing bias in the direction of the width of the pulley, and preventing backlash.

FIG. 11 is a diagram of a power transmitting device 100 equipped with the toothed belt 110 of the invention, and a power transmitting device 200 equipped with a prior art toothed belt 210 having straight teeth. In some experiments, table T is conveyed on the belt from one pulley 120 (220) shown on the left side of FIG. 11 to the other pulley 120 (220) shown on the right side, i.e., in direction DA. In these experiments, the direction of travel is defined as the “advance” mode, setting a position A as the origin. In other experiments, table T is conveyed in the reverse direction, i.e., in direction DB. In these experiments, the direction of travel is defined as the “return mode”, setting position B as the origin. The positioning accuracies of the table T measured at positions A and B respectively in the “advance” and “return” modes are compared.

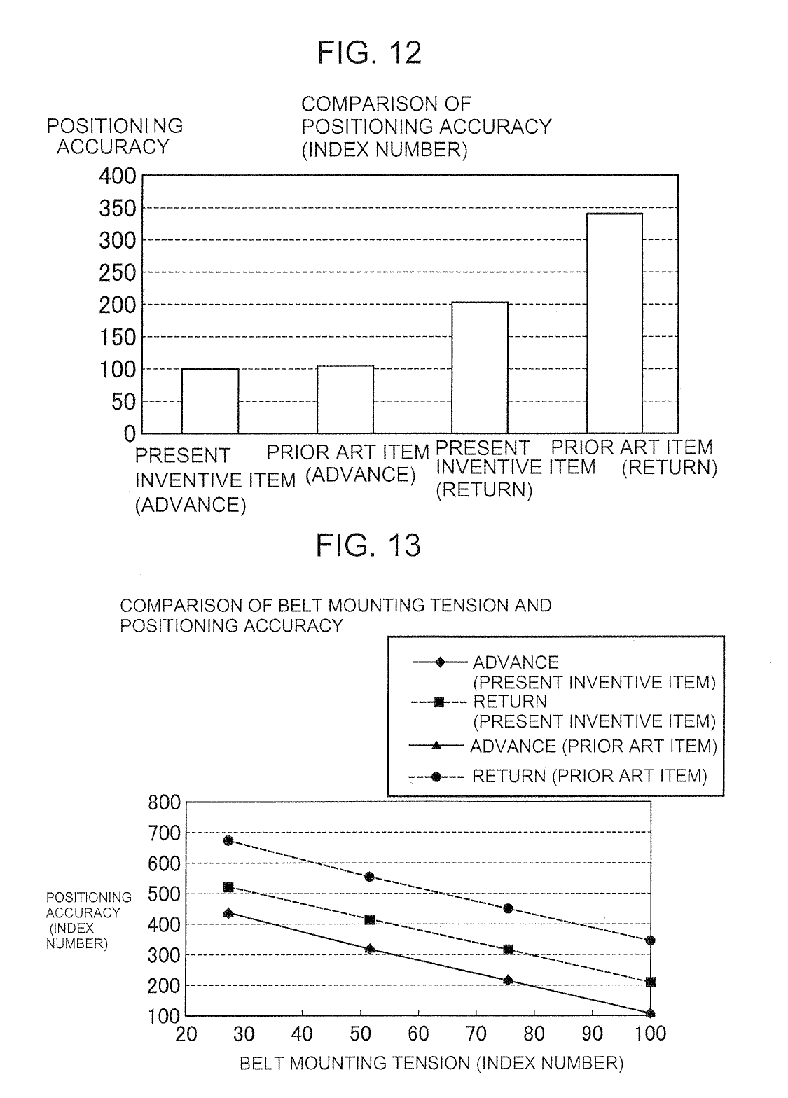

As shown in FIG. 12, the positioning accuracy of the invention in the “advance” mode is equal to that of the “advance” mode of the prior art belt. However, the positioning accuracy of the invention in the “return” mode is 200, while the positioning accuracy of the prior art belt in the “return” mode is 340. This represents an improvement of about two-thirds in the positioning error of the invention as compared to the prior art belt. Without wishing to be bound by any particular theory, the inventors think that the improvement in positioning accuracy in the return mode is due to the reduction of backlash and the improvement of the rigidity in the belt.

As shown in FIG. 13, the invention also considerably improves the positioning accuracy of the table T in the “return” mode independent of belt mounting tension.

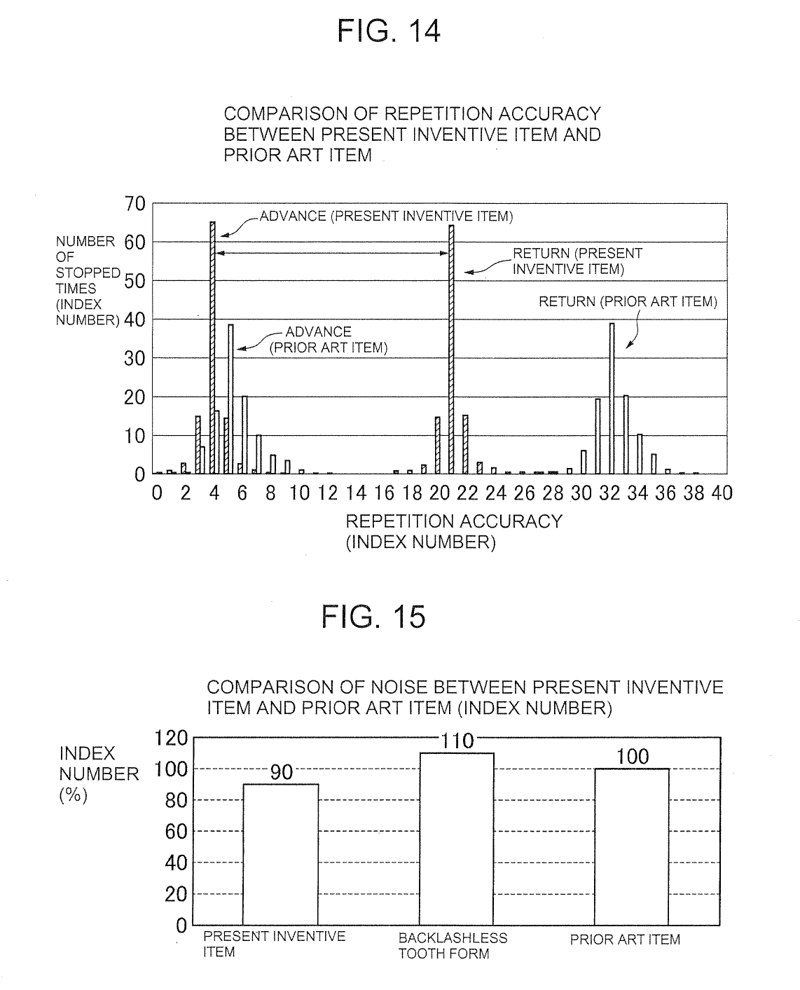

As shown in FIG. 14, the invention considerably improves the repetition accuracy as compared to the prior art belt. The invention shows an equal number of stopped times in the “return” mode described above as compared to the “advance” mode described above. These results show that repetition accuracy is improved by suppressing backlash.

As shown in FIG. 15, the index number of the noise of the belt of the invention is 90, as compared with an index number of 110 for the belt having a “backlashless” tooth form and an index number of 100 for the straight-toothed belt. The invention prevents rattling noise that would otherwise be generated from contact between the belt teeth 115 and the pulley teeth 122.

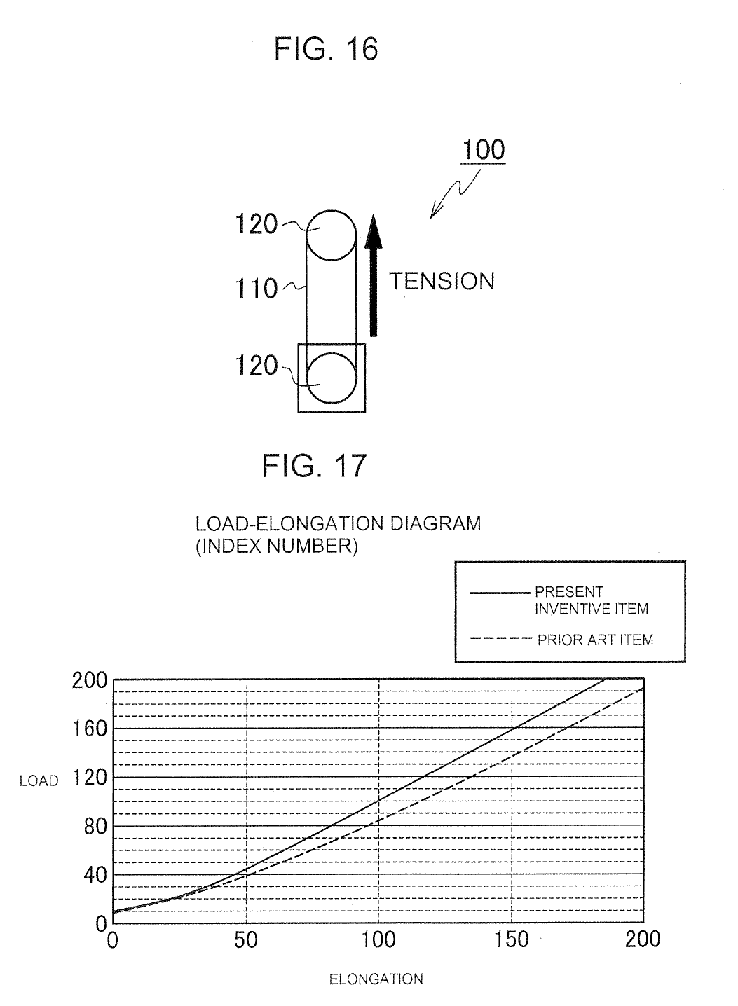

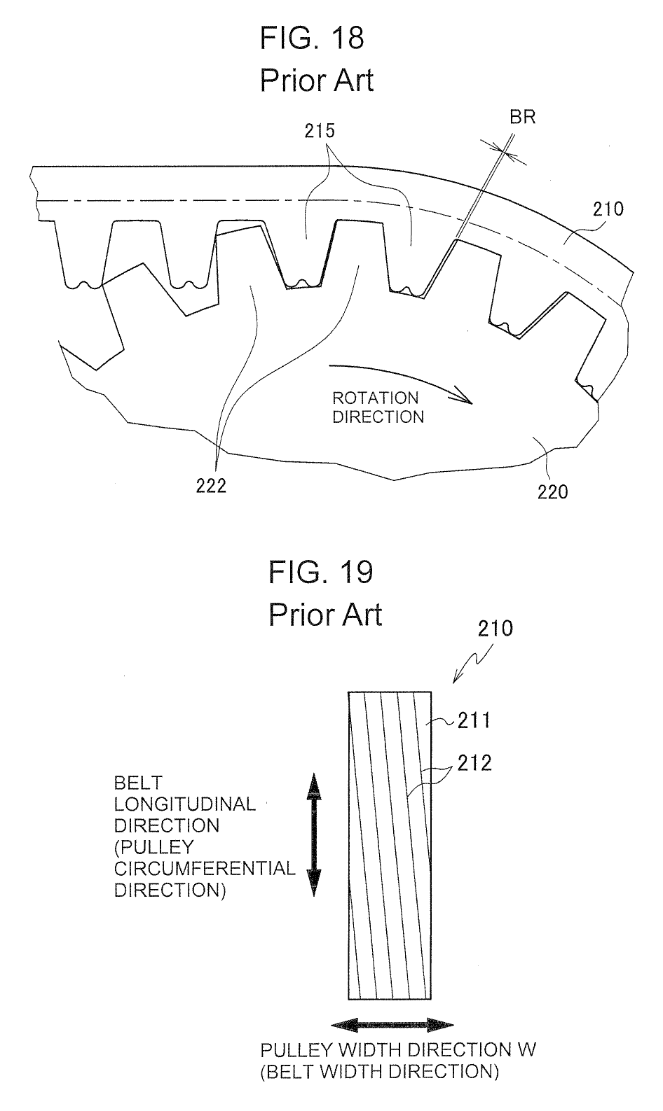

As shown in FIG. 16, the load with respect to the elongation is measured by pulling toothed belt 110 in a device in which one of the pulleys 120 is fixed. As shown in FIG. 17, index numbers of load for elongation of the invention are all larger than the index numbers of the straight toothed prior art belt, and elastic elongation of the invention is small as compared to the prior art belt. This shows that the invention has higher rigidity than the prior art belt.

As described above, the toothed belt 110 of the invention can prevent rattling that would otherwise be generated from contact between the belt teeth and the pulley teeth; prevent bias in the direction of the width of the pulley; prevent backlash; improve the positioning accuracy between the belt teeth and the pulley teeth by preventing elastic elongation of the rubber back layer and the toothed layer; prevent contact noise; and improve durability of the pulley and the belt by reducing wear of the belt teeth and the pulley teeth. Thus, the advantageous effects of the toothed belt 110 of the invention are remarkable.

Various modifications can be made to the belt and power transmission described without departing from the scope of the invention as defined by the following claims.

What is claimed is:

1. A power transmission comprising a toothed belt and a toothed pulley in mesh with the toothed belt and rotatable on an axis of rotation, wherein the belt comprises:
a back layer in the form of an endless loop composed of rubber and extending along a circumferential direction;
a toothed layer secured to the back layer, and extending along the back layer in the circumferential direction, the toothed layer also being composed of rubber, and having a plurality of belt teeth extending toward the inside of the loop;
a plurality of core wires embedded in the belt between the back layer and the toothed layer, the core wires extending along the circumferential direction of the loop; and
wherein the pulley comprises a plurality of straight teeth in mesh with the teeth of the belt, the teeth extending widthwise of the pulley and parallel to the axis of rotation of the pulley;
wherein the belt has a width parallel to the direction of the axis of rotation of the pulley and is arranged to travel along a direction of travel perpendicular to the direction of the axis of rotation of the pulley;
wherein the pitch of the pulley teeth is equal to the pitch of the belt teeth; and
wherein the belt teeth extend at an oblique angle α with respect to the direction of the width of the belt.

2. The power transmission according to claim 1, wherein the twisting direction of each of the plurality of core wires is the same.

3. The power transmission according to claim 2, wherein the belt teeth are tapered such that the width narrows as the tooth extends from the belt.

4. The power transmission according to claim 1, wherein the oblique angle α is greater than 0 degrees but less than or equal to 0.5 degrees.

5. The power transmission according to claim 1, wherein the belt teeth are tapered such that the width narrows as the tooth extends from the belt.

6. A toothed belt comprising:
a back layer in the form of an endless loop composed of rubber and extending along a circumferential direction;
a toothed layer secured to the back layer, and extending along the back layer in the circumferential direction, the toothed layer also being composed of rubber, and having a plurality of belt teeth extending toward the inside of the loop;
a plurality of core wires embedded in the belt between the back layer and the toothed layer, the core wires extending along the circumferential direction of the loop; and
wherein the belt has a width perpendicular to the circumferential direction; and
wherein the belt teeth extend at an oblique angle α with respect to the direction of the width of the belt.

7. The toothed belt according to claim 6, wherein the twisting direction of each of the plurality of core wires is the same.

8. The toothed belt according to claim 7, wherein the belt teeth are tapered such that the width narrows as the tooth extends from the belt.

9. The toothed belt according to claim 6, wherein the oblique angle α is greater than 0 degrees but less than or equal to 0.5 degrees.

10. The toothed belt according to claim 6, wherein the belt teeth are tapered such that the width narrows as the tooth extends from the belt.
